(19) United States
(12) Patent Application Publication
(10) Pub. No.: US 2014/0317925 A1
(43) Pub. Date: Oct. 30, 2014

(54) HEATING DEVICE OR METHOD FOR REPAIRING OR PRODUCING COMPONENTS OF A WIND POWER PLANT AND PARTS THEREOF, AND WIND POWER PLANT

(71) Applicant: Wobben Properties GmbH, Aurich (DE)

(72) Inventors: Sven Muschke, Schortens (DE); Steffen Himsel, Aurich (DE); Uwe Rahmann, Mittegrossefehn (DE)

(21) Appl. No.: 14/358,381

(22) PCT Filed: Nov. 12, 2012
(86) PCT No.: PCT/EP2012/072393

§ 371 Date: May 15, 2014

(30) Foreign Application Priority Data
Nov. 16, 2011 (DE) 10 2011 086 453.9

(51) Int. Cl. B29C 73/34; H05B 3/34; B29C 73/30; H05B 1/02

(52) U.S. Cl. CPC B29C 73/34; H05B 1/0294; H05B 3/34; B29C 73/30
USPC 29/889.1; 219/528; 219/494; 219/526; 165/61

(57) ABSTRACT

There is provided a heating device for use in the repair or production of a component of a wind power installation, in particular a rotor blade of a wind power installation. The heating device has a mat with at least one peripherally extending passage open to one side, and a vacuum tube in the at least one passage. The at least one peripherally extending passage divides the mat into a first and a second portion. A heating unit is provided in the region of the first portion. The air in the region of the first portion can be sucked away through the vacuum tube in the at least one passage.

### BACKGROUND

1. Technical Field

The present invention concerns a heating device for use in the repair or production of components of a wind power installation, a method of repairing or producing components of a wind power installation, and a wind power installation.

2. Description of the Related Art

Components of modern wind power installations, such as for example the rotor blades, are nowadays at least partially made from glass fiber reinforced plastic (GRP), carbon fiber reinforced plastic (CRP) or the like. Production and repair, for example of the rotor blades, requires heat which can be provided, for example, by a heating unit.

In that case the heat produced by the heating unit has to be transmitted with as little loss as possible to, for example, the rotor blade or other components of the wind power installation.

### BRIEF SUMMARY

One or more embodiments of the present invention is to provide an improved heating device which also permits improved transmission of the heat produced to the component to be repaired or produced.

In one embodiment there is provided a heating device for use in the repair or production of a component of a wind power installation, in particular a rotor blade of a wind power installation. The heating device has a mat (for example of silicone, polyurethane (PUR) or another flexible material) with at least one peripherally extending passage open to one side, and a vacuum tube in the at least one passage. The at least one peripherally extending passage divides the mat into a first and a second portion. A heating unit is provided in the region of the first portion. The air in the region of the first portion can be sucked away through the vacuum tube in the at least one passage.

In an aspect of the present invention the heating device has at least one first temperature sensor in the region of the first portion. The heating device further has a control unit for controlling the heating device in dependence on the temperature detected by the first temperature sensor.

In a further aspect of the invention the heating device has a vacuum connection suction member for connecting a tube to a vacuum pump to suck away the air in the region of the first portion.

In one embodiment, the invention concerns the idea of providing a heating device having a (silicone) mat or a silicone layer, wherein provided in the silicone layer are a heating unit and at least one passage having a vacuum tube. A portion of the heating device can be put under vacuum by the vacuum tube so that that portion is fixed to or adheres to a component to be repaired or produced. Preferably the heating device has a vacuum connection member or a suction connection member to which a tube of a vacuum pump can be connected. The connection member is in turn connected to the vacuum tube or the first inwardly open passage. The passage or the at least one passage surrounds a first portion. The heating unit is provided within that portion. Optionally there can be provided at least one temperature sensor in the first portion. Upon activation of the vacuum pump the air in the region of the first portion is sucked out (when the heating device is placed on a component) so that the first portion adheres to the component.

Optionally there can be provided on the heating device a control unit which controls both the vacuum pump and also the heating unit. Control of the control unit can be effected for example in dependence on the output signals of the at least one temperature sensor. The vacuum tube can be for example in the form of a spiral coil tube.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic plan view of a heating device in a first embodiment,

FIG. 2 shows a cross-section A-A through the heating device of the first embodiment,

FIG. 3 shows a view of the underside of the heating device of the first embodiment,

FIG. 4 shows a diagrammatic view of a wind power installation in a second embodiment,

FIG. 5 shows a diagrammatic view of an underside of a heating device in a third embodiment,

FIG. 6 shows a diagrammatic view of the outside of the heating device of the third embodiment,

FIG. 7 shows a diagrammatic sectional view of a heating device of a third embodiment,

FIGS. 8a and 8b show a diagrammatic view of a heating device in a fourth embodiment, and

FIG. 9 shows a diagrammatic sectional view of a heating device of a fifth embodiment.

### DETAILED DESCRIPTION

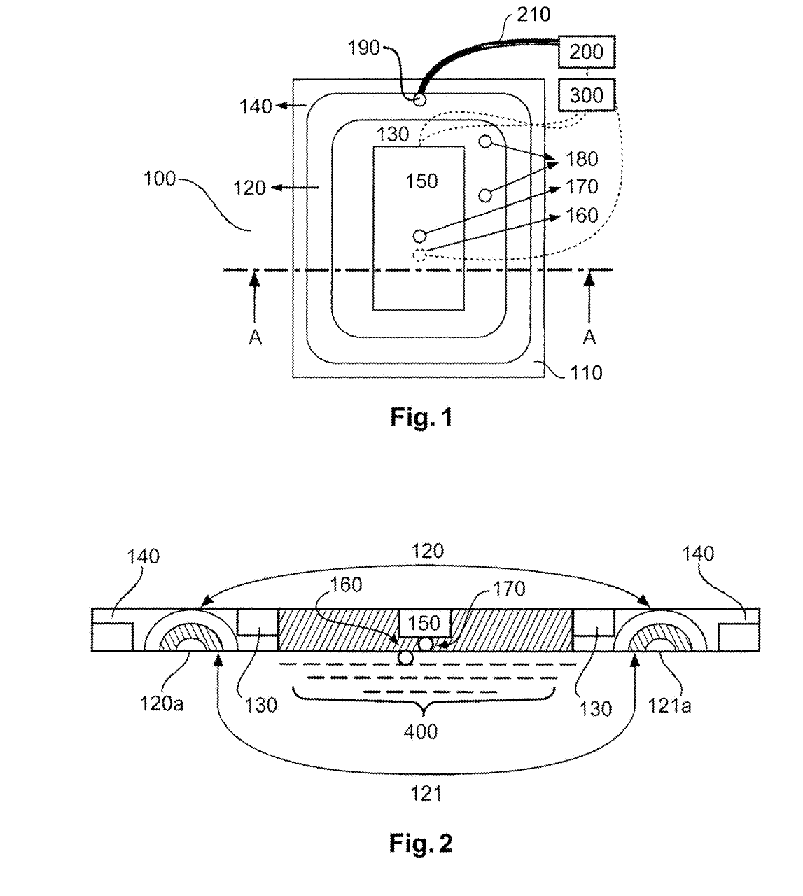

FIG. 1 shows a diagrammatic plan view of a heating device of a first embodiment. The heating device 100 of the first embodiment has a mat 110, for example a silicone mat, with at least one passage 120 which surrounds a first portion 130. A heating unit 150 is provided in the region of the first portion 130. A second portion 140 is provided outside the passage 120. Provided in the passage 120 is a vacuum tube or hose having a plurality of openings in the open end of the passage 120. The heating device 100 also has a vacuum connection or a suction connection member 190 which can be connected by way of a tube 210 to a vacuum pump 200. Optionally there can be provided at least one first temperature sensor 170 in the first and/or second portion 130, 140. That temperature sensor 170 serves to detect the temperature in, at or in the region of, the heating unit 150. A second external temperature sensor 160 can be positioned between the heating unit 150 and a repair location or a location to be treated in order to detect the temperature directly on or in the proximity of the repair location. The heating device can further have a control unit 300 which is connected to the heating unit 150 and/or the vacuum pump 200 and can control operation of the vacuum pump 200 and/or operation of the heating unit 150.

Optionally the (silicone) mat 110 can have in the region of the first portion 130 two openings 180 which can serve as a connection for an infusion resin. Particularly in the repair of rotor blades of a wind power installation or other elements such as for example the pod of the wind power installation it is often necessary for the location to be repaired (or the repair location) or a location 400 to be treated in an infusion process, in which case for example a resin is applied to the repair location and then has to harden. For that purpose the resin is introduced into the first portion 130 through the openings 180.

The heating device is placed on an element to be repaired or produced (repair location 400), and the vacuum pump 200 is activated so that the air between the (silicone) mat 110 in the first portion 130 and the element to be repaired or produced is sucked away. A vacuum is thus produced in the region beneath the first portion 130. That is particularly advantageous because in that way it is possible to avoid air bubbles in the region of the first portion or beneath it. The vacuum tube or hose 121 within the passage 120 can be for example in the form of a spiral coil tube so that openings in the tube coincide with the open side of the passage so that air which is in the region of the first portion can be sucked away.

In accordance with the first embodiment therefore there is provided a heating device having a mat 110, for example a silicone mat, at least one first peripherally extending passage 120 and at least one heating element 150 (for example an electric heating element). The peripherally extending passage 120 divides the (silicone) mat 110 into first and second portions 130, 140. Provided in the at least one passage is a vacuum tube or hose 121 which can be connected to a vacuum pump 200. Air in the region of the first portion 130 can be sucked away by means of the vacuum tube 121 in the at least one passage 120 so that there is a vacuum in the region of the first portion 130 (between the silicone mat and the component to be processed).

FIG. 2 shows a cross-section A-A of the heating device of the first embodiment. The heating device has a mat 110, for example a silicone mat, with at least one passage 120 which divides the mat 110 into a first portion 130 (surrounded by the passage) and a second portion 140 (outside the passage). A heating unit 150 is provided in the region of the first portion 130. Provided in the peripherally extending passage 120 with an open end 120a is a vacuum tube 121 having openings 121a to the open end 120a of the passage 120. In addition a first temperature sensor 170 is optionally provided in or on the heating unit 150 and a second external temperature sensor 160 is optionally provided between the repair location or the location 400 to be treated.

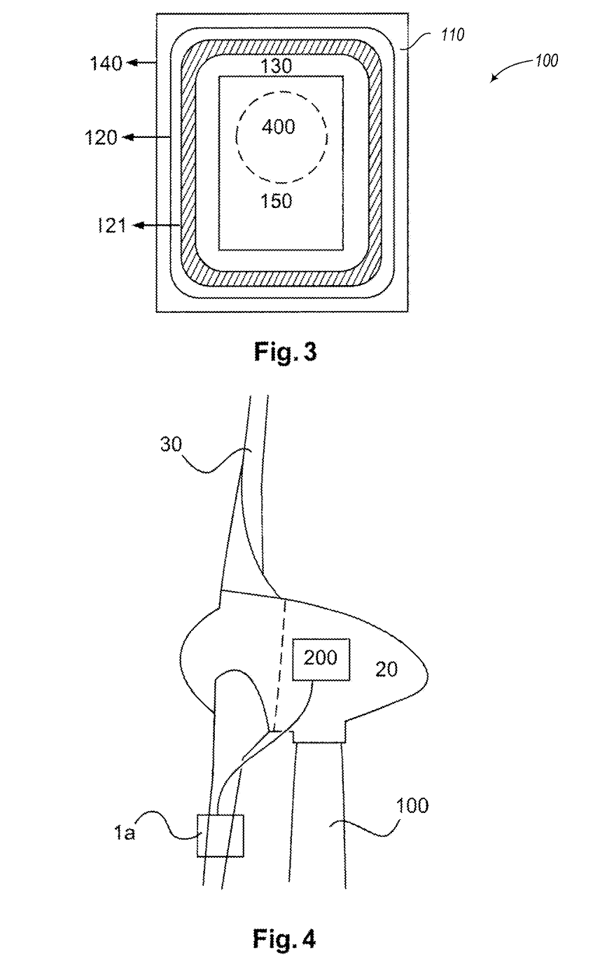

FIG. 3 shows a plan view of the underside of the heating device of the first embodiment. The heating device has a mat 110 and at least one peripherally extending passage 120 dividing the mat 110 into a first and a second portion 130, 140. Provided in the passage 120 is a vacuum tube or hose 121 which for example can be in the form of a spiral coil tube. When the vacuum pump 200 is activated, then the air between the first portion 130 and a component to be processed (repair location or location 400 to be treated) is extracted so that there is a vacuum in the region of the first portion 130. The mat can ‘cling’ to the component to be processed, due to the vacuum in the region of the first portion 130. The air in the region of the first portion 130 is sucked away by the vacuum pump 200 (FIG. 1).

If the heating device of the first embodiment is used for repair or service of a rotor blade of the wind power installation then the mat 110 can be fixed to the rotor blade for example by way of clamping belts. The air in the region of the first portion is then sucked away by means of the vacuum pump 200 which can be controlled by way of the control unit 300 so that a vacuum is produced there and the silicone mat remains clinging to the rotor blade.

The invention also concerns in a second embodiment a heating unit for example as described in accordance with the first embodiment, and a control unit for controlling the heating unit. The heating unit 150 has at least one temperature sensor 170 in the first portion 130 and optionally a second temperature sensor 160 provided outside the first portion or on the outside of the first portion (that is to say between heating unit and repair location). That second temperature sensor can serve as a redundant safety measure. The heating unit further has a control unit 300 which, by means of the at least one first and/or second temperature sensor 170, measures the temperature variation for example when repairing a rotor blade of a wind power installation, for example if a matrix is applied to a location to be repaired on a wind power installation rotor blade, the matrix then being heated by means of the heating device to harden the matrix. In that case the actual temperature of the matrix or the earphone can be detected in or at the repair location. That makes it possible to recognize exothermy so that the supply of energy or heat by means of the heating unit can be throttled. In that case the heating power of the heating unit can be reduced or the heating unit 150 can be for example deactivated when a temperature threshold value is exceeded.

The provision of two independent temperature sensors provides for redundant temperature monitoring, that is to say if one of the temperature sensors measures defective values then temperature monitoring can be effected on the basis of the measurement values of the other temperature sensor. It is possible in that way to ensure that at no time is there an excessive temperature at the location to be treated. It is thus further possible to avoid the component to be treated or the heating unit being damaged. In addition it is possible to avoid the repair location becoming cooked by an excessively high reaction temperature.

In an aspect of the present invention there are preferably provided at least two independent sensors (temperature sensors 160, 170), connected to the control unit 300. Those two temperature sensors 160, 170 are preferably in the form of independent sensors to be able to monitor fault-free implementation of temperature control of the location to be treated or the repair location. The control unit 300 receives the output signals of the first and second temperature sensors 170, 160. The first temperature sensor 170 is provided in, at or in the region of, the heating element 150. Preferably the first temperature sensor 170 is provided centrally in or at the heating unit. Accordingly that first temperature sensor 170 monitors the temperatures which occur in the heating process directly in or at the heating unit 150.

The second temperature sensor 160 can be provided for example between the repair location (or the location to be treated) 400 and the heating unit 150. That second temperature sensor 160 can thus be in the form of an external (temperature) sensor and serves to detect the (exact) temperature at the repair location or the location to be treated.

The control unit 300 serves to control a time and temperature sequence. Optionally the control unit can have a plurality of time and/or temperature sequences. The time and temperature sequence can be adapted if that is desired.

After application of the matrix for repair or production of an element, the matrix can be heated to a temperature of 40° C. by means of the heating unit 150. That temperature can optionally be maintained for example for two or three hours. In that case the temperature signal of the first and/or second temperature sensor 170, 160 is monitored to permit exothermy detection. If for example the temperature rises above 40° C. then the heating power output of the heating unit 150 is reduced or the heating unit is switched off. After that the heating unit 150 is only activated again when the temperature measured by the first and/or second temperature sensor 170, 160 falls below a threshold value. The matrix can then be heated for example to 80° C. by the heating unit being further operated for some hours.

As a safety precaution the control system can optionally be activated if the first or second temperature sensor is defective. The second temperature sensor can be provided as a redundant temperature sensor to detect exothermy.

To control hardening of the resin applied to the repair location the control unit 300 can for example have two temperature modes. The first temperature mode can represent a 40° C. mode and the second mode can represent an 86° C. mode. It should be pointed out however that the actual numbers of degrees can be adapted to the correspondingly used resins. Therefore reference is only made by way of example hereinafter to the 40° C. mode and the 86° C. mode. The first temperature mode (40° C.) and then the second temperature mode (86° C.) are described hereinafter.

In the first temperature mode the reaction of the resin mixture (linking of the molecules) is slowly set in operation. By switching the heating element 150 on and off alternately (+/−2° C. of the target value) the temperature is kept on average at about 40° C. That first temperature mode is used at the beginning of the reaction to cause the reaction temperature to slowly and controlledly increase. Preferably the first temperature mode involves exothermy detection. The second temperature sensor 160 detects the temperature directly at the repair location or the location 400 to be treated. In that way a temperature rise can be detected permanently or at intervals. In order to be able to exclude for example weather-governed temperature fluctuations the control unit 300 has a threshold temperature value which must be exceeded to activate exothermy detection. If that threshold value is not exceeded (for example due to excessively low ambient temperatures) then the control unit 300 actuates the normal pre-programmed time interval and only thereafter switches into the second temperature mode.

If exothermy detection is started then the maximum temperature can be stored. With some resin mixtures for example the maximum reaction temperature can already be reached after about 45 minutes, the reaction temperature thereafter gradually falling. If the maximum temperature falls for example by at least 0.5° C. in 10 minutes, then the control unit 300 detects that exothermy is concluded. If the temperature then falls for example by a further 0.2° C. the control unit 300 can switch from the first temperature mode into the second temperature mode. The first temperature mode can be considerably shortened by the exothermy detection.

The resin mixture is completely hardened in the second temperature mode (for example 86° C. mode). The temperature at the repair location or the location 400 to be treated is kept at about 86° C. by switching the heating unit 150 on and off alternately (that is to say +/−2° C. of the target value).

The mat 110 can represent for example a silicone mat, a PUR mat or a mat of another flexible material.

FIG. 4 shows a diagrammatic view of a wind power installation according to a third embodiment. The wind power installation has a pylon, a pod and rotor blades 30. The wind power installation has a vacuum pump in the region of the pod and at least one air tube and a power supply for the heating mat, which tube can be passed outwardly and can serve as an air tube for a heating mat as described hereinbefore.

A flap can be provided in the region of the pod 20, through which flap the at least one air tube can be passed. The wind power installation also has a heating unit as has been described in accordance with the first or second embodiment. In addition the wind power installation can have a control unit for controlling the above-described heating unit and for controlling the vacuum pump.

FIG. 5 shows a diagrammatic view of an underside of a heating device according to a third embodiment. The heating device of the third embodiment can be based on a heating device according to the first embodiment. The heating device 100 has a mat 110 with an electric heating unit 150. The heating unit 150 has a heating conductor 151 and an electric feed line 152. The heating unit 150 can be for example in the form of a heating radiator, wherein the heating conductor 151 is provided in a meander shape in or on the mat 110. The heating device can have a temperature sensor 170 with a feed line 171. The temperature sensor 170 can be sewn centrally in the heating mat. The spacing between adjacent windings of the heating conductor 151 can be for example 15 mm. The electric feed line 152 can be introduced at a corner of the heating device and sewn there so that the connection is water-tight. At its periphery the mat 110 can at least partially have a portion 111 without heating conductor 151, which is to be kept as small as possible.

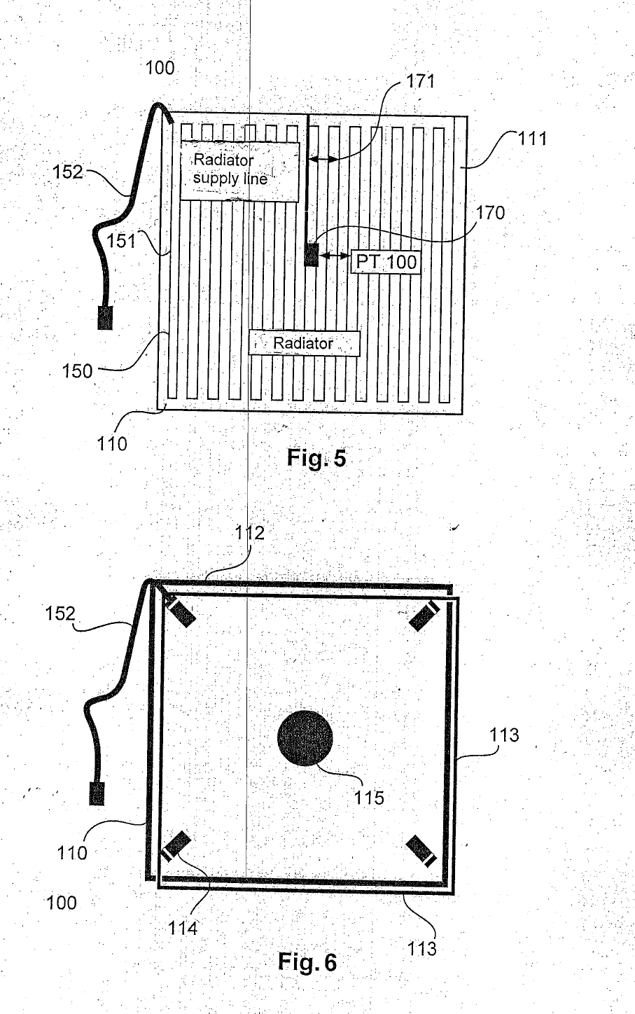

FIG. 6 shows a diagrammatic view of the outside of the heating device according to the third embodiment. The heating device 100 has a mat 110 with a heating unit 150, an electric feed line 152, an optional border portion 112, at least partially a fixing for example in the form of a zip fastener 113, a hook-and-loop fastener 113 or a Velcro band, optionally loops 114 for handling the mat and optionally a marking 115 for marking the position of the temperature sensor 170. A heating device can be connected to an adjacent heating device by means of the zip fasteners 113 or the Velcro band (hook-and-loop fastener) 112. The rubber border portion 112 serves for better adhesion for an adhesive band when the heating device is mounted for example on a rotor blade.

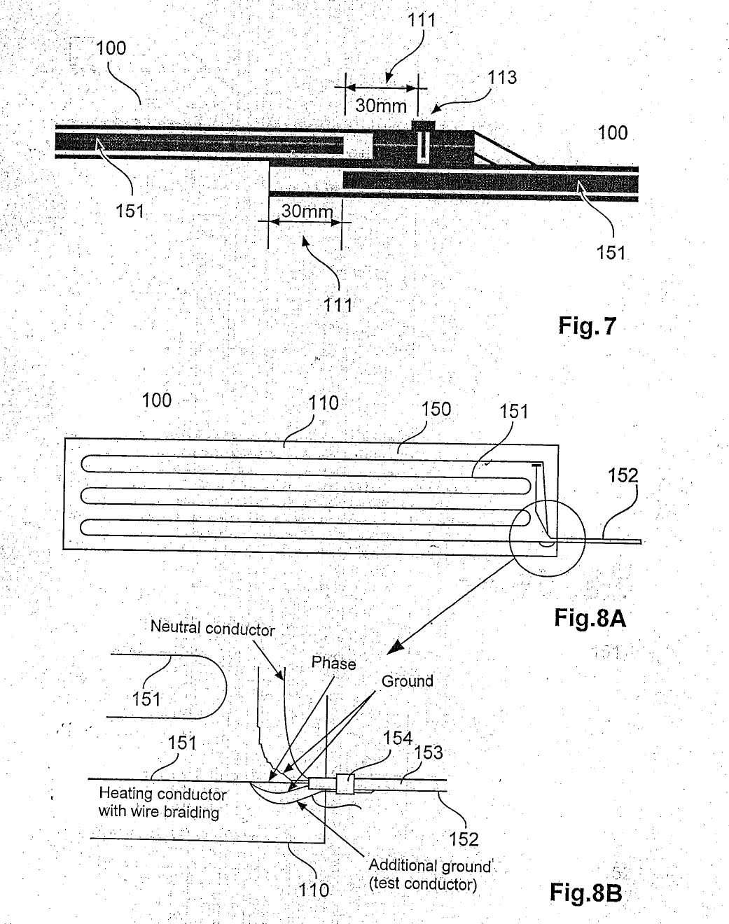

FIG. 7 shows a diagrammatic sectional view of a heating device according to a third embodiment. FIG. 7 shows two interconnected heating devices. The two heating devices are connected together by way of a zip fastener 113. The two heating devices each have a heating wire 151 and a region 111 in which there is no heating wire so that this region can represent a cold zone or a non-heatable portion.

FIGS. 8a and 8b show a diagrammatic view of a heating device according to a fourth embodiment. The heating device 100 has a mat 110 with a heating unit 150 for example in the form of a heating radiator. The heating unit 150 has a heating conductor 151 arranged in a meander shape. The heating device has an electric feed line 152. The heating conductor 151 has a wire, an insulation surrounding it and a metal shielding for example in the form of a wire braiding 153. In that way the heating conductor can have a metal core, an insulation and therearound on the outside a shielding of metal. A (codable) plug 154 can be provided between the electric feed line 152 and the heating conductor 151. The plug can have for example eight pins, wherein a first pin is connected to a neutral conductor, a second pin to a phase, a third and fourth pin respectively to a temperature sensor and an eighth pin to ground (PE).

In the fourth embodiment which can be based on the first, second or third embodiment the heating conductor 151 in the region of the mat has over its entire length a metal shielding for example in the form of wire braiding. The two ends (input/output) can preferably be connected to ground and to the protective conductor respectively.

In the fourth embodiment the heating conductor or heating wire can be monitored to check whether the insulation is properly present. In the case of a defect with the protective conductor that defect can be outputted optically/acoustically. If a fault occurs in operation that can be indicated optically and/or acoustically. If a fault appears before the beginning of a heating process then the heating process is not started.

Preferably an isolating transformer can be provided between the heating device and a supply network so that this provides for galvanic separation. It is thus possible to ensure that the user is not put at risk.

The isolating transformer can be provided in or at the heating device or the control for the heating device or can be provided as a separate unit between the heating device and the supply network.

According to one embodiment the heating device has a mat of a textile cloth. The heating device has a heating unit with a heating wire, wherein the heating wire has an insulation for example of silicone and a metal shielding for example in the form of a wire braiding. The two ends of the metal shielding of the heating wire are connected to the protective conductor so that a fault current can flow away by way of the protective conductor.

According to one or more embodiments of the invention the electrical connections of the heating device are water-tight.

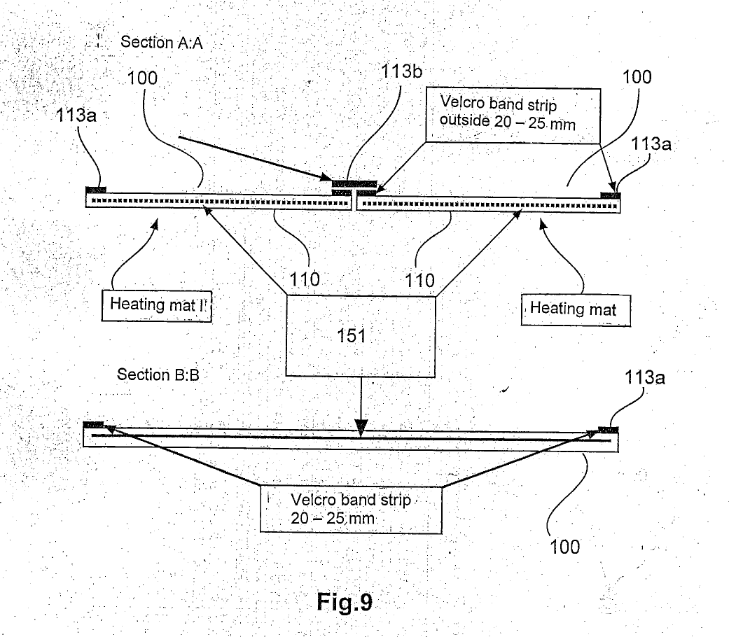

FIG. 9 shows a diagrammatic view in section of a heating device according to the fifth embodiment. The heating device of the fifth embodiment can be based on one of the preceding embodiments. The heating device 100 of the fifth embodiment can have a plurality of mats 110 with a heating unit 150 and a heating wire 151. The two mats 110 can each have at their respective ends a Velcro band strip (for example for a hook-and-loop fastener) 113a. To connect two heating mats 110 together the two heating mats 110 are placed one beside the other and a Velcro band strip 113b (for example for hook-and-loop fastening) is placed on the adjacently arranged Velcro band strip 113a so that the two heating mats are joined together. Such a configuration could suffer from the disadvantage that there is a colder portion, while on the other hand it avoids the possibility of hot spots, that is to say regions where two heating conductors are arranged one above the other and the temperature at that location becomes excessively great.

In a further embodiment of the invention which can be based on one of the foregoing embodiments the heating mat has an RFID chip for identification purposes. The identification stored in the RFID chip can be read by a reading device and stored in a data bank, for example SAP. It is thus possible to see where and how the heating device has been used.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A heating device for use during repair or production of a component of a wind power installation, the heating device comprising:
a mat having a first side and at least one peripherally extending passage that opens to the first side, wherein the at least one peripherally extending passage divides the mat into a first portion and a second portion;
a vacuum tube in the at least one peripherally extending passage, the vacuum tube being configured to suck away air in a region of the first portion; and
at least one heating unit provided in the region of the first portion of the mat.

2. The heating device according to claim 1 further comprising:
a first temperature sensor in the region of the first portion; and
a control unit for controlling the heating unit in dependence on the temperature detected by the first temperature sensor.

3. The heating device according to claim 2 further comprising:
a second temperature sensor in a region between the at least one heating unit and a repair location of the component,
wherein the first temperature sensor is located in a substantially central region heating unit,
wherein the control unit is adapted to control the heating unit in dependence on the temperature detected by at least one of the first and second temperature sensors.

4. The heating device according to claim 1 wherein the first temperature sensor located in a substantially central region of the heating unit.

5. The heating device according to claim 1 further comprising:
a vacuum connection suction member for connecting a tube of a vacuum pump to suck away the air in the region of the first portion.

6. The heating device according to claim 2 wherein:
the control unit is adapted to control operation of the heating unit in dependence on the temperature detected by at least one of the first and second temperature sensors,
wherein the control unit is adapted to perform exothermy detection of a matrix used for repair or production of the component on a basis of the temperature measured by at least one of the first and second temperature sensors and to reduce the heating power output of the heating unit when an exothermy has been detected,
wherein the control unit is adapted to increase the heating power output of the heating unit upon a decline in exothermy.

7. The heating device according to claim 1 wherein:
the control unit has a first temperature mode and a second temperature mode, wherein the control unit is adapted in the first temperature mode to control operation of the heating unit in dependence on the temperature detected by at least one of the first and second temperature sensors, to provide for exothermy detection of the matrix used, to detect a decline in exothermy by monitoring the temperature detected by at least one of the first and second temperature sensors, and to switch from the first into the second temperature mode, and
the control unit in the second temperature mode is adapted to increase the heating power output of the heating unit and maintain the heating power output for a predetermined time interval.

8. The heating device according to claim 7 and further comprising:
a cooling unit in the region of the heating unit,
wherein the control unit is adapted to control operation of the cooling unit and to activate the cooling unit when the temperature detected by at least one of the first and second temperature sensors rises above a threshold rate.

9. The heating device according to claim 1 wherein the at least one heating unit has a heating wire and an electric feed line, wherein the heating wire includes a first and a metallic shielding, the heating wire being configured to be connected to ground at the first and second. ends.

10. A method of repairing or producing a rotor blade of a wind power installation, using a heating device that includes a mat with a peripherally extending passage that opens to one side, and a vacuum tube in the passage, wherein the passage divides the mat into a first portion and a second portion, wherein the heating device has at least one heating unit in the region of the first portion, the method comprising:
sucking away air in the region of the first portion through the vacuum tube, wherein sucking away the air causes the first portion of the mat to press against the rotor blade; and
heating the first portion.

11. The method according to claim 10 wherein:
during a first temperature mode:
detecting a first temperature in or at the heating unit or between the heating unit and a second temperature at a location to be repaired or treated,
controlling the heating unit in dependence on at least one of the first and second temperature, and
recognizing exothermy of the matrix used in dependence on at least one of the first and second temperature, and
at least one of reducing and switching off the heating power output of the heating unit when an exothermy recognized is recognized, and
activating a second temperature mode by at least one of increasing and switching on the heating power output of the heating unit when a decline in exothermy has been detected.

12. A wind power installation comprising:
a pod;
a vacuum pump in the pod;
a tube having a first end and a second end, the first end of the tube coupled to the vacuum pump; and
the heating device according to claim 1, wherein the second end of the tube is coupled to the vacuum tube.

13. The wind power installation according to claim 12 wherein the pod has at least one flap for the vacuum tube to pass through.

14. The wind power installation according to claim 12 comprising a control unit for controlling the heating device.

15. The heating device according to claim 1 wherein the component is a rotor blade.
